(19) United States
(12) Patent Application Publication
(10) Pub. No.: US 2024/0082609 A1
(43) Pub. Date: Mar. 14, 2024

(54) FILTRATION ELEMENT AND USES THEREOF

(71) Applicant: Sion Biotext Medical Ltd., Sderot (IL)

(72) Inventors: Yulia Holenberg, Ramat Hagolan (IL); Marina Holenberg, Ramat Hagolan (IL); Daniel Lev, Western Galilee (IL)

(21) Appl. No.: 18/263,500

(22) PCT Filed: Jan. 31, 2022
(86) PCT No.: PCT/IL2022/050135

§ 371 Date: Jul. 28, 2023

(30) Foreign Application Priority Data
Jan. 31, 2021 (IL) 280523

(51) Int. Cl. A62B 23/02; A41D 13/11; A41D 31/14; B01D 39/16

(52) U.S. Cl. CPC A62B 23/025; A41D 13/11; A41D 31/145; B01D 39/1623; B01D 2239/0421; B01D 2239/0428; B01D 2239/0618; B01D 2239/0622; B01D 2239/0627; B01D 2239/0672; B01D 2239/1233; B01D 2239/1291

(57) ABSTRACT

The present disclosure provides a filtration element comprising a proximal filtration layer, a distal filtration layer and at least one filtration layer placed between said proximal filtration layer and said distal filtration layer, each filtration layer comprising a non-woven (NW) fabric having a filtration degree; wherein the proximal filtration layer and the distal filtration layer have, independently, a filtration degree that is lower than the filtration degree of the at least one filtration layer placed between said proximal filtration layer and said distal filtration layer. Also provided by the present disclosure is a personal protective equipment comprising the disclosed filtration element and a method of protecting a subject body using the same.

### TECHNOLOGICAL FIELD

The present technology concerns filtration elements.

### BACKGROUND ART

References considered to be relevant as background to the presently disclosed subject matter are listed below:
U.S. Pat. No. 8,091,550
German Patent No. DE10323326
U.S. Pat. No. 4,925,561
International Patent Application Publication No. WO2016167960
Chinese Patent Application No. CN107174768
U.S. Pat. No. 6,761,169
US Patent Application Publication No. 20180160748
European patent Application Publication No. 1899038
Korean Patent No. 101476916
U.S. Pat. No. 6,277,178
Chinese Patent Application Publication No. 107982815
Chinese Patent Application Publication No. 105771421
Chinese Patent Application Publication No. 110754720
Chinese Patent Application Publication No. 111248542
Chinese Patent Application Publication No. 104585920

Acknowledgement of the above references herein is not to be inferred as meaning that these are in any way relevant to the patentability of the presently disclosed subject matter.

### BACKGROUND

The Covid-19 pandemic outbreak led to the development of numerous new technologies with the mutual goal of fighting the spread of the disease and/or defeating the virus. Among the various products being developed, efforts are made to provide new and improved anti-microbial face masks.

There are different types of face masks, some of which are based on the principles of volumetric filtration.

U.S. Pat. No. 8,091,550 describes a face mask that includes a body portion that is configured to be placed over a mouth and at least part of a nose of a user such that the air of respiration is drawn through the body portion. The body portion includes a baffle layer which prevent penetration from a fluid striking the mask. The baffle layer has an outer and an inner surface with a plurality of projections extending from one of the outer or inner surfaces and distributes fluid away form the point of impact in the channels between the projections.

DE10323326 describes a filter comprises a number of parallel flow channels. The channels have a maximum cross section at the entry, with a constant tapering to the exit. Half the flow channels take unfiltered air with their openings at the entry into the filter, and the remaining channels take filtered air to their openings at the exit. The channels are arranged alternately, with common walls of a filter material, through winding or layering a filter strip and a dividing strip, with folds along folding lines to act as spacers. Each spacer is a double spacer to support the flanking filter strips with a channel structure, using identical folding surfaces with a flat surface.

U.S. Pat. No. 4,925,561 describes a face mask having construction similar to that described in U.S. Pat. No. 8,091,550, yet having two pleated filtering mediums and at least one roughly flat filtering medium interposed between the pleated filtering mediums. Each pleated filtering medium has an end constituted by edges of triangular bottom sections and the other end constituted by edges of triangular top sections.

WO2016167960 describes a filter unit to be used in a mask and that is capable of removing fine particles and odors. The unit can be made up of multiple layers by winding one multifunctional sheet into many layers, which are lined up on any virtual line extending from inflow to outflow of the filter such that virtual surface is set in an aspect that blocks the flow of gas. The layers of filtering materials are of different functions—one to separate the dust particles using surface filtration principles, the second to remove toxic gases or odors (adsorption).

CN107174768 describes an anti-haze mask with Fish Gill Type Filter working in a similar principle as described in WO2016167960.

U.S. Pat. No. 6,761,169 reports on bi/multi-directional filter cartridge that includes a filter pad and a filter pad base, capable of connecting the unit to a source of suction. The filter pad includes: outer filter walls made of a filter material suitable for filtering at least particulates; and a gas/vapor adsorber/absorber member, located within the inner area defined by the outer filter walls, the filter walls maintaining a spacing between inner surfaces of the walls and the gas/vapor adsorber/absorber member, wherein the gas/vapor adsorber/absorber member includes an adsorber/absorber upstream portion of its outer surface structured to, in response to a source of suction, receive air that has already been filtered by the filter walls, such that the air passes through at least a minimum length of the gas/vapor adsorber/absorber member and then out of an opening in the filter pad at a downstream portion of the gas/vapor adsorber/absorber member.

US20180160748 describes a mask made of a single layer resin film having air permeability through the thickness thereof the resin film is a non-porous film having through holes extending through the thickness of the film, the diameter of the through holes being between 0.01-30 μm, which provides filtration degree of 30 microns, and the density of the through holes in the resin film is between 10-1×10⁸ holes/cm²

EP1899038 describes a microbicidal air filter which includes an immobilization network with at least one antimicrobial agent. The network is protected from outside with air permeable screen elements, which provide preliminary air filtration and as a result improve the lifetime of the filtering element.

KR101476916 describes a protective garment in which air is first filtered through a foam layer and then pass-through antibacterial units.

U.S. Pat. No. 6,277,178 describes a respirator including a filter cartridge made of a housing and a bonded sorbent filter element, working as standard volumetric filter.

CN107982815 describes a filtration type gas mask comprising a mask body, and a separation layer arranged in the mask body transversely. The mask body is divided into a visual area located on the upper portion and a breath area located on the lower portion through the separation layer. A filter is in threaded connection with the outer surface of the breath area and comprises a shell in a shape of a circular truncated cone. A multiple thread connection part is arranged at the upper end of the shell. A gas outlet net plate is arranged at the top of the shell. A gas inlet net plate is arranged at the bottom of the shell. An activated carbon layer, a nanocarbon crystal layer, a PP cotton layer, a melt-blowing cloth layer and a nonwoven layer are arranged in the shell sequentially from top to bottom.

Finally, Chinese Patent Application Publication Nos. 105771421, 110754720, 111248542, and 104585920 describe different filtration masks.

### GENERAL DESCRIPTION

The present disclosure relates, in accordance with a first of its aspects, to a filtration element comprising a proximal filtration layer, a distal filtration layer and at least one sandwiched filtration layer between said proximal filtration layer and said distal filtration layer, each filtration layer comprising a non-woven (NW) fabric having a first filtration degree, wherein the proximal filtration layer and the distal filtration layer have, independently, a filtration degree that is lower than the first filtration degree, i.e. of the at least one filtration layer sandwiched (i.e. placed between) the proximal filtration layer and the distal filtration layer.

Further provided by the present disclosure, in accordance with a second aspect, is a method for protecting a subject body, the method comprising wearing/applying onto the subject's body or part thereof a filtration element comprising a proximal filtration layer, a distal filtration layer and at least one filtration layer placed between said proximal filtration layer and said distal filtration layer, each filtration layer comprising a non-woven (NW) fabric having a determinable filtration degree; wherein the proximal filtration layer and the distal filtration layer have, independently, a filtration degree that is lower than the filtration degree of the at least one filtration layer sandwiched/placed between the proximal filtration layer and the distal filtration layer.

Yet further, the present disclosure provides, in accordance with a third of its aspects, a method of producing a personal protective equipment (PPE), the method comprises superimposing a proximal filtration layer, a distal filtration layer and at least one additional filtration layer, sandwiched/placed between said proximal filtration layer and said distal filtration layer, each filtration layer comprising a non-woven (NW) fabric having a first filtration degree, wherein the proximal filtration layer and the distal filtration layer have, independently, a filtration degree that is lower than the first filtration degree, i.e. of the at least one filtration layer sandwiched therebetween.

Finally, there is provided a personal protective equipment (PPE) comprising the filtration element disclosed herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic illustration of a five layered filtration element in accordance with one example of the present disclosure (FIG. 1A) and the volumetric fluid flow channel (FIG. 1B) formed from a construction of a type illustrated in FIG. 1A.

FIGS. 2A-2F are microscopic images of three non-woven (NW) fabrics, taken from two sides of each NW fabric and showing the fibers diameters (in micrometer (jam), units not shown for simplicity of the figure) of the NW fabrics according to Table 4, with FIGS. 2A-2B being images of a fabric material “A”, FIGS. 2C-2D being images of a fabric material “B”, and FIGS. 2E-2F being images of a fabric material “C”.

FIG. 3 is a graph showing the hydraulic resistance as a function of time, of each of the three tested NW fabrics once placed, each separately, in sand carrying water (#1 being fabric A, #2 being fabric B and #3 being fabric C according to Table 4).

FIG. 4 is a graph showing percent particle removal from the sand carrying water, by each of the three different tested NW fabrics (#1 being fabric A, #2 being fabric B and #3 being fabric C according to Table 4), the data is based on samples of the water taken every 5 minutes from placement of each of the fabrics in the ‘contaminated’ water.

FIG. 5 a graph showing the hydraulic resistance (pressure drop) as a function of time, of the three layers ((#1 being fabric A, #2 being fabric B and #3 being fabric C according to Table 4) in comparison to layer C (#3) alone, once the layered or the single fabric are each placed in sand carrying water.

FIG. 6 is a graph showing percent particle removal from the sand carrying water, by a filtration element comprising the three different tested NW fabrics (#1 being fabric A, #2 being fabric B and #3 being fabric C according to Table 4), in comparison with that of fabric C (#3) alone; the data is based on samples of the water taken every 5 minutes from placement of each of the fabrics in the ‘contaminated’ water.

FIG. 7 is a schematic illustration of an apparatus for measuring pressure drop using a filtration element disclosed herein.

FIG. 8 is an image of the respirator face masks constructed in accordance with an embodiment (AFCCB) of the present disclosure, the masks being in their final shape as tested for filtration efficacy and other performances.

### DETAILED DESCRIPTION

With the outbreak of the Covid-19 virus, a medical face mask (respirator) that is selectively impermeable to airborne particles and liquid (droplets and aerosol) has become a crucial element in the fight against the spread of the disease.

The present disclosure is based on the development of a filtration element such as a face mask, or a wearable protective suit, that comprises a filtering element made of layers of non-woven fabrics having different filtration degrees, the layers being organized one with respect to another in a manner resembling a structure of a sand clock or a hourglass with the layers of a lower filtration degree (relative to other layers in the entire element) placed between a layer with a higher filtration degree. Such arrangement defines a unique volumetric filtration configuration, allowing for longer duration of use once the filtration element is worn on a subject's body, as compared to conventional surgical masks (e.g. the commonly used N95 mask).

The present disclosure is based on Applicants' finding that selective removal of contaminants (“particle removal” or in short “PR”) using layers of different volumetric filtration degree allows different particle removal mechanisms to take place, including any one or combination of inertial impaction, diffusion, direct interception, electrostatic retention, gravitational deposition and for a longer duration as compared to conventional surgical masks. In addition, the selective arrangement of the layers allows the large particles and droplets to be entrapped in the outer, sandwiching/external layers having a low filtration degree as compared to the sandwiched (e.g. higher porosity, lower pressure drop), while smaller particles are entrapped in the sandwiched (inner) layers having a higher filtration degree (e.g. lower porosity). The inner/sandwiched layers (with the higher filtration degree/lower porosity) trapping the smallest particles. The terms “sandwiched” and “inner” are used herein interchangeably.

When referring to a “sandwiched layer” it is to be understood to refer to at least one layer placed between the proximal layer and the distal layer. Thus, the present disclosure provides, in accordance with a first of its aspects a filtration element, for use in protecting a subject's body, e.g. face mask, the filtration element comprising a proximal filtration layer (configured to face a subject's body and/or to be in contact with a subject's body), a distal filtration layer and at least one filtration layer placed/sandwiched between the proximal filtration layer and the distal filtration layer, each filtration layer comprising a non-woven (NW) fabric having a first (definable) filtration degree; wherein the proximal filtration layer and the distal filtration layer have, independently, a filtration degree that is lower than the filtration degree of the sandwiched filtration layer(s).

In the context of the present disclosure, when referring to a filtration element it is to be understood as a device or part of a device, that is configured to filter air born contaminants, thereby preventing their reach onto or into a subject's body. The filtration should preferably be in accordance with acceptable Standards. For example, the filtration performance (capacity) can be in accordance with The National Institute for Occupational Safety and Health (NIOSH) requirements, such as one determined by testing in compliance with 42 CFR Part 84 and NIOSH Procedure No. RC-APR-STP-0057, 0058 and 0059. In some other examples, the filtration performance (capacity) can be in accordance with the American Society of Testing and Materials (ASTM), such as ASTM F2100-19 (the standard specification for performance of materials used in medical face masks).

In accordance with some examples of the present disclosure, the filtration element is defined by its overall particle removal capability or in other words, its filtration degree.

Further, in the context of the present disclosure, the term “filtration degree” is to be understood to mean the percent of particle removal (% PR) by the filtration element or component thereof. In this connection, it is to be noted that a filtration degree does not necessary correlate with the density of the fibers in the layer. Thus, for examples, two layers or sheets can have the same density and yet, exhibit a different filtration degree, as shown in the Exemplary Table 4 below with respect to sheets B and C. The differences in filtration degree between two layers or sheets having the same density can be due to differences in chemistry, hydrophobicity etc. In this connection, when referring to a “first filtration degree” it is to be understood to refer to the filtration degree of the layer placed between the proximal layer and the distal layer.

The degree of filtration can be determined in various ways, depending, inter alia, on the standard test used.

In accordance with some examples of the present disclosure, the degree of filtration is determined in compliance with 42 CFR Part 84 and NIOSH Procedure No. RC-APR-STP-0057, 0058 and 0059.

In accordance with one other example of the present disclosure, the degree of filtration is determined in compliance with ASTM F2100-19. Specifically, filtration efficacy is determined by challenging the filtering element with NaCl aerosol at 25±5° C. and relative humidity of 30±10% at flow rate of up to 85 liters per minute. The particle size distribution is 0.075±0.020 micrometers and a geometric standard deviation not exceeding 1.86. The filtration efficacy and hydraulic resistance are continuously checked during the test.

The filtration degree is determined with reference to 100% removal (absolute rating) of particles/solids above a specified micron rating on a single pass basis. An absolute rating of 0.3 micron (100% PR 0.3 micron) means that no particles of 0.3 micron or larger will pass through the filter. Similarly, a filtration degree of 90% (90% PR) at 0.3 micron, means that 90% particles of 0.3 micron or larger do not pass through the filtration element.

The filtration element includes layers of non-woven fabric, including the proximal layer, the distal layer and at least one sandwiched layer (filtration layer placed between said proximal filtration layer and said distal filtration layer). In the context of the present disclosure, it is to be understood that each of the filtration layers can comprise, independently, one or combination of types and/or sheets of non-woven fabrics. The degree of filtration of the filtration layer can be different from that of the individual sheets and is to be defined by determining the degree of filtration of the layer per se comprising the stacked sheets of non-woven fabrics superimposed on essentially or at least partially over the other.

In some examples, the filtration element comprises a proximal layer comprising a single type of non-woven fabric. In some other examples, the proximal layer comprises one sheet of non-woven fabric. In yet some other examples, the proximal layer comprises two or more, superimposed sheets of the same non-woven fabric. In some examples, the proximal layer comprises two or more sheets of at least two different non-woven fabrics.

Preferably, the proximal layer comprises a single type of non-woven fabric.

In some examples, the filtration element comprises a distal layer comprising a single type of non-woven fabric. In some other examples, the distal layer comprises one sheet of non-woven fabric. In yet some other examples, the distal layer comprises two or more, superimposed sheets of the same non-woven fabric. In some examples, the distal layer comprises two or more sheets of at least two different non-woven fabrics.

Preferably, the distal layer comprises a single type of non-woven fabric.

The sandwiched layer (filtration layer placed between said proximal filtration layer and said distal filtration layer) can comprise a single type of different types of non-woven fabric.

In some examples, the filtration element comprises a sandwiched layer, i.e. placed between the distal layer and the proximal layer, that comprises a single type of non-woven fabric. In some other examples, the sandwiched layer comprises one sheet of non-woven fabric. In yet some other examples, the sandwiched layer comprises two or more, superimposed sheets of the same non-woven fabric. In some examples, the sandwiched layer comprises two or more sheets of at least two different non-woven fabrics.

In the context of the present disclosure, when referring to non-woven fabric it is to be understood as having the meaning acceptable in the industry. Thus, a non-woven fabric would be any fabric-like material made of fibers of different lengths (staple fibre/short fibers and long fibers) bonded together by any one or combination of chemical, mechanical, heat and solvent treatment. The non-woven fabric typically has a web structure with fibers or filaments mechanically, thermally, or chemically entangled together. The non-woven fabrics are porous and can be defined by differences in their porosity. The porosity of the fabric can be dictated by the fibers' average diameter and/or by the fibers' density. For example, a non-woven fabric having a fibers' density of 25 gr/m² would be considered to be more porous than a fibers' density of 35 gr/m². Similarly, a non-woven fabric having an average fibers diameter of 10-20 micron would be considered to be more porous than a non-woven fabric having an average fibers diameter of 25 micron.

There are different types of non-woven fabrics. At times, these are divided into groups in accordance with their manner of manufacturing. Without being limited thereto, the non-woven fabrics can be Staple (Drylaid), Melt-blown, Spunlaid (Spunbond/Spunlace), Flashspun, Airlaid, Wetlaid and others.

In some examples, at least one layer comprises Spunbond 35 gr/m²

In some examples, at least one layer comprises Spunbond 25 gr/m²

In some examples, at least one layer comprises Meltblown 25 gr/m²

In some examples, at least one layer comprises 100% PET

In some examples, at least one layer comprises Aquaspun-B 40 gr/m²

In some examples, at least one layer comprises Hydrophilic PP/PE 50 gr/m² 1.05 mm depth (PE coated hydrophilic PP spunbond).

The filtration layers can also be defined by their level of hydrophobicity.

It has been found to be of advantage when the filtration element includes at least one hydrophilic non-woven fabric. Without being bound by theory, it appears that the hydrophilic layer captures water molecules and prevents them from clogging the hydrophobic layers of the filtration element, thereby reducing the pressure drop of the filtration element.

In some examples, the filtration element comprises at least one layer that comprises a hydrophilic NW fabric.

In some examples, the filtration element comprises a hydrophilic non-woven fabric at least in the proximal filtration layer, preferably with the hydrophilic non-woven fabric being configured to be in contact with the subject's body/face.

In some examples, the filtration element comprises a hydrophilic NW fabric as part of the distal filtration layer.

In some examples, the filtration element comprises a hydrophilic NW fabric as part of the sandwiched layer. In some examples, the sandwich (filtration layer placed between said proximal filtration layer and said distal filtration layer) hydrophilic NW fabric is juxtaposed with the distal layer.

In some examples, the filtration layer comprises at least two hydrophilic NW fabrics, wherein at least one hydrophilic NW fabric forms or constitutes part of the proximal filtration layer and at least one other hydrophilic NW fabric forms or constitutes part of the filtration layer placed between the proximal filtration layer and the distal filtration layer.

The filtration layers are combined to form the filtration element. The combination of the layers, and thereby the fabrics forming the layers, can be by any conventional technique. For examples, the fabrics can be fixedly attached to each other using hot welding techniques. Further, for example, the fabrics can be fixedly superimposed one to another using sewing techniques. The fixation can be at any location along the layers, but would preferably be at least at peripheral sections/portions of the filtration element (of the superimposed fabrics/layers).

In some examples, the non-woven fabric and thus the filtration layer formed therefrom, is defined by the layer's (fabric or combination of fabrics) filtration degree at a defined particle size. In some examples, the filtration degree is defined by challenging the filtering element with NaCl aerosol at 25±5° C. and relative humidity of 30±10% at flow rate of up to 85 liters per minute. The particle size distribution is 0.075±0.020 micrometers and a geometric standard deviation not exceeding 1.86. The filtration efficacy and hydraulic resistance are continuously checked during the test. Different standards can differ in the flow rate, such as with ASTM.

In some examples, a filtration layer can be defined by its capacity, which means the ability of the filtering element to hold airborne particles without being clogged. A capacity test provides information on the overall time the filtration element can be in use.

The filtration element disclosed herein is characterized by a high filtration degree, and high capacity as compared to other commercially available filtration elements.

In some examples, the filtration degree of the filtration element disclosed herein, when determined according to NIOSH standard (42 CFR Part 84 and NIOSH Procedure No. RC-APR-STP-0057, 0058 and 0059) as also described herein, is at least 91%, at times at least 92%; at times, at least 93%; at times, at least 94%; at times, at least 95%; at times, at least 96%; at times, at least 97%; at times, at least 98%; at times, at least 99%.

In some examples, the filtration element has a capacity (determined as described herein) of at least 120 minutes, at times, at least 150 minutes; at times, at least 170 minutes; at times, at least 200 minutes; at times, at least 220 minutes; at times, at least 240 minutes; at times, at least 260 minutes; at times, at least 280 minutes; at times, at least 300 minutes; at times, at least 320 minutes; at times, at least 340 minutes; at times, at least 360 minutes; at times, at least 380 minutes; at times, at least 400 minutes; at times, at least 360 minutes; at times, at least 380 minutes; at times, at least 400 minutes; at times, at least 420 minutes; at times, at least 440 minutes; at times, at least 460 minutes; at times, at least 480 minutes; at times, at least 500 minutes; at times, at least 520 minutes; at times, at least 540 minutes; at times, at least 560 minutes; at times, at least 580 minutes; at times, at least 600.

In some examples, the filtration element is characterized by its low pressure drop (dP, mmH₂O), also known as the breathing resistance. The pressure drop is defined as the difference in total pressure between two points of the filtration element, e.g. between the external faces of the distal and proximal layers. A pressure drop occurs when frictional forces, caused by the resistance to flow, act on a fluid as it flows through the filtration element. The filtration element is also characterized by its low pressure drop even after a long period of use.

A properly designed filtration element, such as a facemask, should prevent transport of hazardous particles, but allow normal air flow through the filtration element e.g. breathing effort being normal.

The dP can be determined by implementing any acceptable test. In accordance with the present disclosure, the dP can be determined in the same test for determining the filtration degree, where dP is continuously measured using inline integrated Siemens digital manometer.

In some examples, the filtration element disclosed herein is characterized by a high filtration degree, e.g. above 90%, or above 91% or above 92%, or even above 93% (PR % at 0.3 μm), and low pressure drop, e.g. below 12, or even below 11 (mmH₂O), the filtration degree or pressure drop being determined as described in connection with Table 4 hereinbelow.

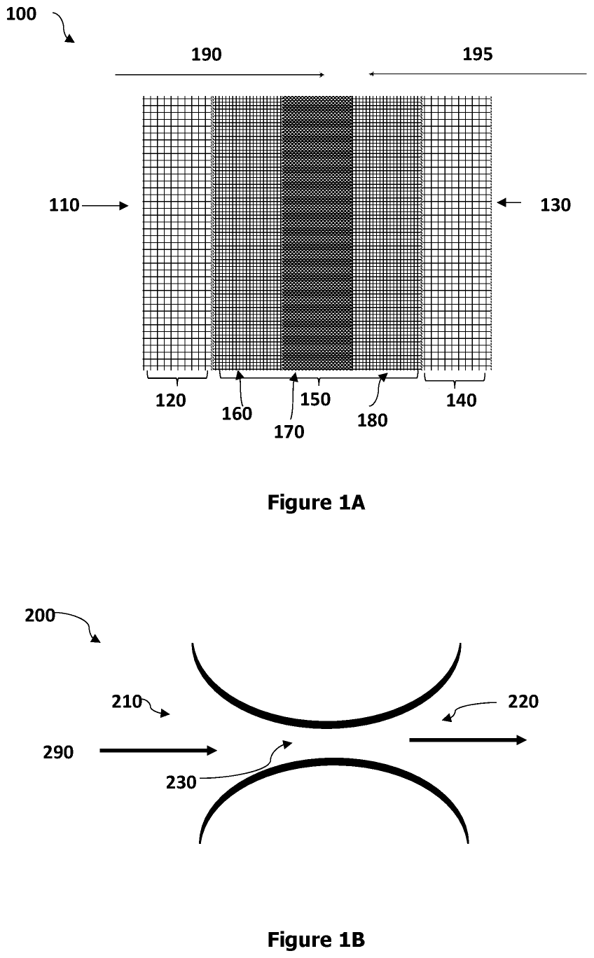

FIG. 1A provides a schematic illustration of a possible arrangement of five sheets of non-woven fabrics of a filtration element 100 in accordance with a non-limiting example of the present disclosure. Specifically, the arrangement includes a proximal end 110 comprised of proximal layer 120, a distal end 130 comprised of distal sheet 140, and a sandwiched layer 150 comprised of three sheets 160, 170 and 180, at least one of the sandwiched sheets 160, 170 and 180 have a filtration degree that is greater than that of proximal layer 110 formed of sheet 120 and distal layer 130 formed of sheet 140. The illustrated filtration element can be used for the construction of a respirator (face mask). As illustrated, the filtration element comprises a distal end, configured to face the environment, once the respirator is worn on a subject's face, and a proximal end, configured to face a subject's skin. FIG. 1A also illustrates the flow direction upon use during breathing, with the direction of flow 190 during exhalation and direction of flow 195 during inhalation.

The proximal end comprises the proximal layer and the distal end comprises the distal layer, having a same defined degree of porosity, which is illustrated by a wide grid.

Between the proximal layer and the distal layer, there is a sandwiched layer (a layer placed between said proximal layer and said distal layer), composed of three fabrics, arranged such that the two flanking fabrics have a grid that is wider than that of the mid fabric, and yet narrower than that of the distal and proximal layers.

The filtration element disclosed herein provides a plurality of pores defining a fluid flow channel having a shape resembling an hourglass structure. FIG. 1B illustrated a flow channel 200 of a single pore obtained as a result of the layer's arrangement, with the flow channel 200 having a wide fluid inlet 210 and wide fluid outlet 220 and a narrow mid section 230. Also illustrated is the direction of flow 290 through the pore's inlet 210.

The filtration element may include a body fixation element to ensure essential fixation of the filtration element over the body or over a body part, such as the face.

The filtration element can be used in various applications, particularly in the field of personal protective equipment (PPE).

In some examples, the filtration element forms part of a garment to be worn on a subject's body or part thereof. Thus, the present disclosure also provides a body protecting garment comprising a filtration element described herein.

In one example, the personal protective equipment is a face mask/respirator, comprising the filtration element and optionally a fixation element, configured for fixating the filtration element to the face.

In one example, the personal protective equipment is a lab outfit or lab rob, comprising the filtration element and optionally a fastening element, configured for fastening the filtration element over the body.

The filtration layer is used in a method of protecting a subject's body. To this end, a method is disclosed according to which the filtration element, be in in a form of a respirator, an outfit or any other personal protective equipment (PPE) form, is applied onto a subject's body or body part, e.g. onto the face or onto the body, respectively.

Finally, a method of producing the filtration element is disclosed. The method comprises superimposing a proximal filtration layer, a distal filtration layer and at least one additional filtration layer, placed between said proximal filtration layer and said distal filtration layer, each filtration layer comprising a non-woven (NW) fabric having a filtration degree, wherein the proximal filtration layer and the distal filtration layer have, independently, a filtration degree that is lower than the filtration degree of the at least one filtration layer placed/sandwiched therebetween.

### DESCRIPTION OF NON-LIMITING EXAMPLES

### Example 1— Characterization of Filtration Using a Water as the Filtered Fluid

A face mask was prepared using three types of nonwoven (NW) fabrics (polymeric materials) as described in Table 1.

TABLE 1
Nonwoven fabric

| Material | Description | Fibers density |
|---|---|---|
| A | spunbond hydrophilic and / or | 25 gr/m² |
| | hydrophobic material | |
| B | spunbond /hydrophobic material | 35 gr/m² |
| C | Meltblown hydrophobic material, | 25 gr/m² |
| | optionally electrically charged with | |
| | d_{0.95} = 0.1 . . . 0.3 microns | |

The different NW were visualized from both sides using a laboratory microscope Delta Pix with a 100× magnification.

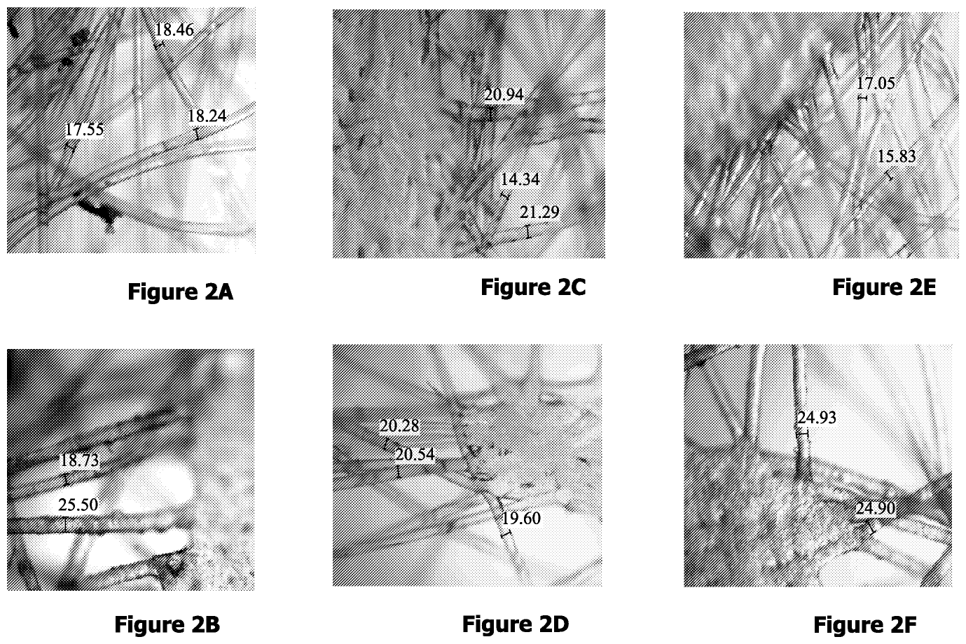

FIGS. 2A-2F show microscopic images of Material A (FIGS. 2A-2B), Material B (FIGS. 2C-2D) and Material C (FIGS. 2E-2F). The microscopic images indicate that the average fibers diameter of Materials A and C are in the range of 10-20 micron while the average fibers diameter of Material B is about 25 micron. This was determined using Delta Pix microscope having a built-in option for size measurement between to selected points.

In addition, filtration and particle removal (PR) capability of each NW material and their combinations was determined using dust containing water prepared by pumping water pre-filtered into 1 micron cartridges containing fine dust A2 ISO (12103-1) in an amount providing a turbidity of 2.5±0.5 nephelometric turbidity unit (NTU). The water flow rate was 1 L/min, which was equal, in terms of differential pressure (dP) to 100 L/min of air. This was determined by calibration method, which included the measurement of differential pressure on the same filtration media with do 95=2 microns both in water and in air. When pressure drop on the filtration media at certain water flow rate becomes equal to the air flow rate for 20 samples of filtration media, these flow rates are considered as test-wise equivalent.

The hydraulic resistance of each material was measured using Siemens DP gauge SITRANS P DS III series and recorded manually every 5 minutes for first 30 minutes of the test and then every 30 minutes. In addition, samples of the filtered water were taken every 5 minutes to determine particle removal.

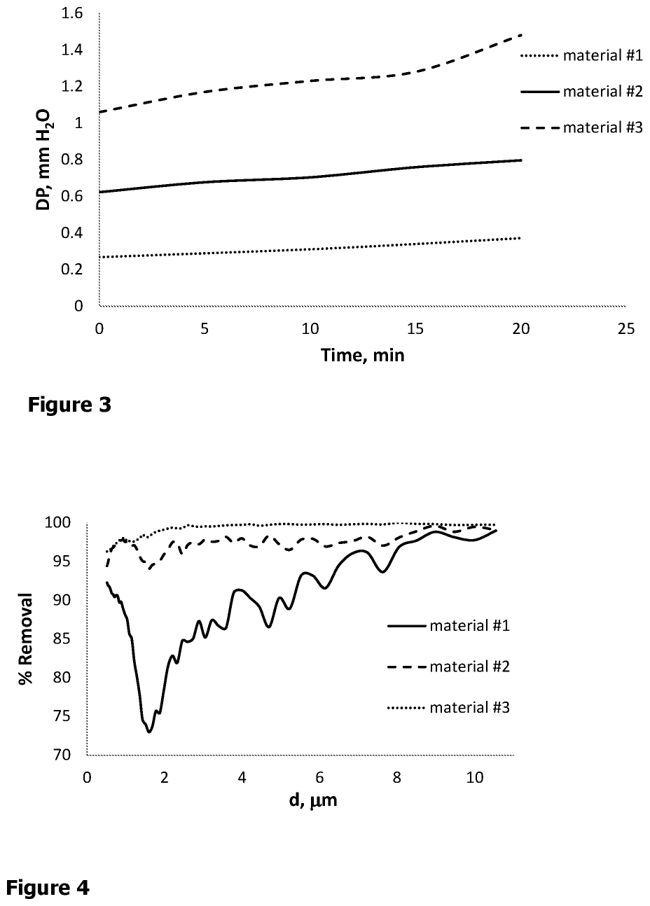

Table 2 provides the hydraulic resistance of the non-woven fabrics, as single layers and as a combination of Material A, Material B and Material C, the results of which are also summarized in FIG. 3 with respect to the single layers.

TABLE 2
Hydraulic resistance on non-woven materials in water

| | dP (mm H₂O) | | | |
|---|---|---|---|---|
| Min | Material A | Material B | Material C | Materials ABC |
| 0 | 0.268 | 0.623 | 1.06 | 1.91 |
| 5 | 0.289 | 0.677 | 1.17 | 1.94 |
| 10 | 0.311 | 0.704 | 1.23 | 1.99 |
| 15 | 0.34 | 0.759 | 1.28 | 2.01 |
| 20 | 0.372 | 0.797 | 1.48 | 2.08 |
| 25 | N/A | N/A | 2.71 | 2.11 |
| 30 | N/A | N/A | 4.1 | 2.18 |
| 60 | N/A | N/A | | 2.5 |
| 90 | N/A | N/A | | 2.15 |

FIG. 3 provide the % of dust removal from the tested water using the different tested materials.

In addition, FIG. 3 and FIG. 4 show that material C provides do 96=0.5 micron with a higher filtration degree for large particles and a high hydraulic resistance, relative to materials B and C. Generally, the hydraulic resistance indicates the breathability of the material, and according to the requirements of ASTM F2100-19 cannot be higher than 5 mm H₂O/cm². This maximal pressure drop allows to breath through the mask, however the breathing is very hard and should be limited for short usage time. In this connection it is noted that ASTM F2100-19 is adequate for surgical procedures where there is a limited duration of use (during surgery only) and thus may allow, alongside with a higher filtration level, a higher pressure drop. However, for a daily (long duration) use, a balance needs to be obtained between the level of filtration on the pressure drop.

When two layers of material C were used, filtration degree of d_{0.98}=0.5 micron was reached. However, initial dP was 6.5 mm H₂O/cm² i.e. above the allowed level and thus the combination of two layers of material C could not be used.

### Combination of Non-Woven Fabrics

The particle removal (PR) from a filtering element comprising a combination of ABC in comparison with the particle removal of Material C only was tested.

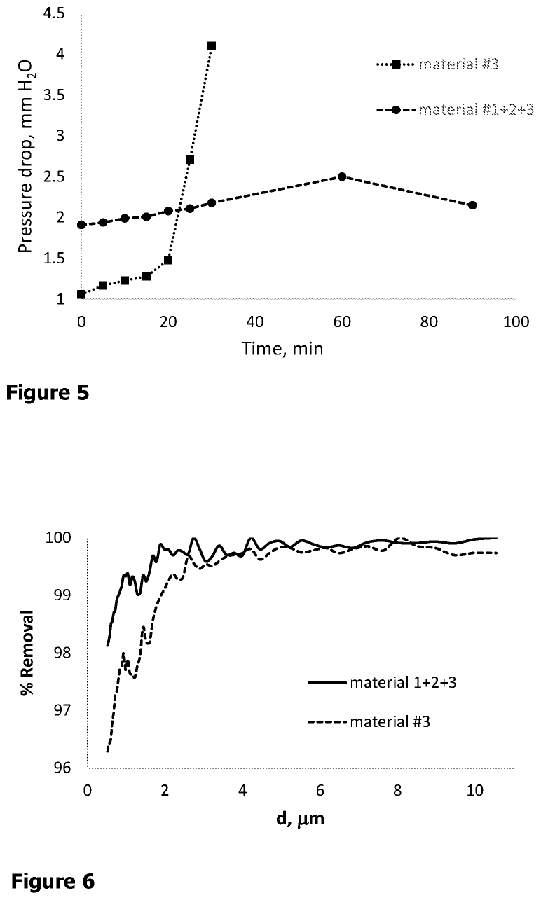

FIG. 5 provides the hydraulic resistance of the three-layer filtration element vs. the hydraulic resistance of material C only.

The initial hydraulic resistance of the three-layered filtration element was 1.91 mm H₂O/cm² while for material C was 1.06 mm H₂O/cm², however dP of the three-layered filtration element remained almost constant with time (increased from 1.91 to 2.08 mm H₂O/cm² within a 20 minute measurement period), while the dP of material C alone increased from 1.06 to 1.48 mm H₂O/cm² during the same period of time. This indicated a higher capacity of the three-layer filtration element. A steep increase in pressure-drop, indicating the filtration element clogging, for material C alone developed in minutes 25-30 from the test beginning. For combination of materials ABC the pressure drop remained constant for 60 minutes, and then reduced, which can indicate mechanical damage of the filtering media due to prolonged test, probably without reaching the maximal filtration media capacity. It is noted that the filters are examined under extreme conditions and thus, the constant pressure drop of 6 minutes should be translated to a significant improvement relative to a single sheet (e.g. material #3).

FIG. 6 shows that the three-layered filtration element had a slightly better removal capacity (2% higher) of the small particles as compared to the single layer (material C) and that the three-layered filtration element reached 100% removal (within the experimental error) at about 2.5-3 microns.

Thus, taking into combination the removal capacity (which is as good or even better than that of a single layer) and the longer duration of filtration for the combined element (1+2+3), shows that advantage of the combined element.

### Example 2— Characterization of Filtration Using—Air as the Filtered Fluid

A face mask was prepared using different combinations of six types of nonwoven (NW) fabrics as described in Table 3.

TABLE 3
Nonwoven fabrics

| Material | Description | Fibers density |
|---|---|---|
| A | Spunbond (hydrophobic) | 25 gr/m² |
| B | Spunbond (hydrophobic) | 35 gr/m² |
| C | Meltblown (hydrophobic) | 25 gr/m² |
| D | 100% PET (hydrophobic) | |
| E | Aquaspun-B (hydrophobic) | 40 gr/m² |
| F | Hydrophilic PP/PE | 50 gr/m² 1.05 mm depth |

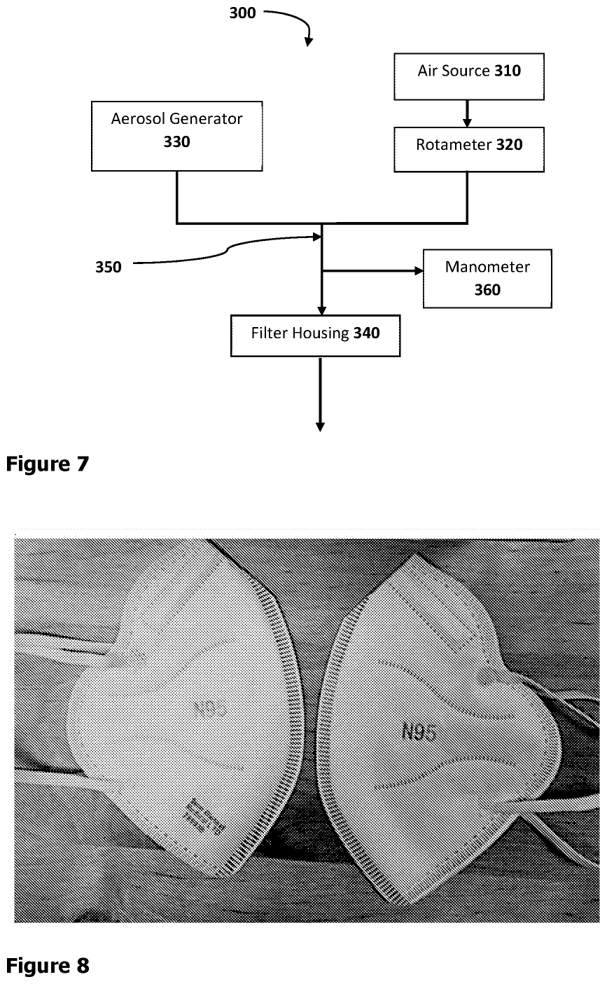

A test apparatus for pressure drop by air was constructed using a rotameter, a manometer, a filter housing, a flow rate valve and filter housing outlet. FIG. 7 provides a schematic illustration of components and operation mode of a test apparatus employed. Specifically, the test apparatus 300 includes air source/supply 310, a rotameter 320, aerosol generator 330, all being in fluid communication to a filter housing 340 which holds the tested filtering element, via the fluid communication line 350. Pressure drop is measured using a manometer 360 connected to the fluid communication line, before the aerosol enters the hosing 340.

During the pressure drop test the tested material is introduced into the filter housing 340.

In operation, the flow rate is brought to the desired level by the rotameter 320 using the flow rate valve (not illustrated) and pressure drop is recorder by the manometer 360.

It is noted that the test is conducted according to ASTMF22101, however, with the NaCl aerosol instead of biological Aerosol of Staphylococcus aureus as the filtered media.

Table 4 represents pressure drop test results for different filtration materials and their different combinations, at flow rate of 28.8 L/m 2 (mmH₂O), in accordance with ASTM F2101 standard (albeit with NaCl aerosol instead of biological Aerosol of Staphylococcus aureus). The test results were averaged over 15 samples and were within a variance of not higher than ±10%.

TABLE 4
Pressure drop at flow rate of 28.8 L/min (NaCl aerosol)

| | | dP, | PR % at |
|---|---|---|---|
| Code | Type | mmH₂O | 0.3 μm |
| A | Spunbond 35 gr/m² | 13.5 | 91.5 |
| B | Spunbond 25 gr/m² | 12.8 | 92.0 |
| C | Meltblown 25 gr/m² | 14.0 | 94.4 |
| D | 100% PET | 11.8 | 79.9 |
| E | Aquaspun-B 40 gr/m² | 12.1 | 91.9 |
| EBA | Aquaspun-B40 gr/m² + Spunbond 25 | 10.8 | 95.1 |
| | gr/m² + Spunbond 35 gr/m² | | |
| EBB | Aquaspun-B40 gr/m² + Spunbond 25 | 17.4 | 93.3 |
| | gr/m² + Spunbond 25 gr/m² | | |
| DBA | 100% PET + Spunbond 25 gr/m² + | 9.4 | 94.0 |
| | Spunbond 35 gr/m² | | |
| DBB | 100% PET + Spunbond 25 gr/m² + | 13.3 | 92.9 |
| | Spunbond 25 gr/m² | | |

From Table 4 one can notice that combinations of materials provide in some cases less pressure drop then one of the materials, included in the composition. For example, combination EBA including a middle layer (B) having a filtration degree (92.0) that is higher than that of its flanking layers (91.5 for A and 91.9 for E), and at least one layer (E) being hydrophilic, had a pressure drop (dP) of 10.8 mmH₂O, and similarly the combination DBA including the middle layer (B) sandwiched between layer A (filtration degree of 91.5) and layer D (filtration degree of 79.9 for D), both being lower in their filtration degree, had dP of 9.4 mmH₂O. Yet, when using layer a combination of DBB the dP=13.3 mmH₂O, which was extremely higher than EBA or DBA.

The combination DBA differs from the combination DBB by the outer (A vs. B). The dP of A was dP=13.5mmH₂O, while that of B is lower, dP=12.8mmH₂O, and yet, the pressure drop of the combination DBA was unexpectedly lower than that of DBB.

This unexpected lower pressure drop of DBA (or EBA) is explained by the unique arrangement of the layers in accordance with a principal of filtration degree increasing towards the center (middle) layer in a manner resembling an hourglass funnel structure.

Four- or five-layer arrangements of the described materials A to F, were prepared and tested in accordance with National Institute for Occupational Safety and Health (NIOSH) recommendations using NaCl aerosol at flow rate of 85 L/min (42 CFR Part 84 and NIOSH Procedure No. RC-APR-STP-0057, 0058 and 0059), averaged over samples, assembled into single use respirator (see FIG. 8 for photographic description of the respirator configuration).

Table 5 provides a description of the layer arrangements.

TABLE 5
Pressure drop at NaCl aerosol at 85 L/min flow rate

| | | dP, | PR % at |
|---|---|---|---|
| Code | Type | mmH₂O | 0.3 μm |
| A | Spunbond 35 gr/m² | 14.9 | 91.2 |
| B | Spunbond 25 gr/m² | 17.4 | 91.7 |
| C | Meltblown 25 gr/m² | 13.5 | 94.6 |
| D | 100% PET | 17.5 | 76.1 |
| E | Aquaspun-B 40 gr/m² | 19.4 | 91.8 |
| F | Hydrophilic PP/PE 50 gr/m² | 13.9 | 92.8 |
| | 1.05 mm depth | | |
| ACCB | Spunbond 35 gr/m² + | 14.3 | 96.1 |
| | Meltblown 25 gr/m² + | | |
| | Meltblown 25 gr/m² + | | |
| | Spunbond 25 gr/m² | | |
| AFCCB | Spunbond 35 gr/m² + | 17.6 | 96.4 |
| | Hydrophilic PP/PE 50 gr/m² | | |
| | 1.05 mm depth + Meltblown 25 | | |
| | gr/m² + Meltblown 25 gr/m² + | | |
| | Spunbond 25 gr/m² | | |
| AFCEB | Spunbond 35gr/m² + | 18.2 | 96.2 |
| | Hydrophilic PP/PE 50 gr/m² | | |
| | 1.05 mm depth + Meltblown 25 | | |
| | gr/m² + Aquaspun-B 40 gr/m² + | | |
| | Spunbond 25 gr/m² | | |

Table 5 shows that the “hourglass funnel arrangement” of the layers provided a higher filtration degree than that of the individual layers. All three tested configurations (ACCB, AFCCB and AFCEB) provided at least 95% filtration efficacy for 0.3 micron aerosol particles.

For the three tested configurations, capacity test was performed under the same working conditions, in which inlet 0.3 micron NaCl particles of count O(10⁵) were floating in aerosol with median diameter of 0.075±0.020 μm and a geometric standard deviation not exceeding 1.86 μm as required by NIOSH standard 42 CFR Part 84. Table 6 provides the capacity results.

TABLE 6
Capacity test results for various filtering element configurations

| | | | | | | | Commercial | |
|---|---|---|---|---|---|---|---|---|
| | ACCB | | AFCCB | | AFCEB | | N95 | |
| Time, | dP, | PR, | dP, | PR, | dP, | PR, | dP, | PR, |
| s | mmH₂O | % | mmH₂O | % | mmH₂O | % | mmH₂O | % |
| 0 | 14.3 | 96.1 | 17.6 | 96.4 | 18.2 | 96.2 | 15.1 | 96.3 |
| 30 | 23.7 | 98.5 | 17.7 | 97.4 | 18.4 | 96.3 | 25.9 | 99.4 |
| 60 | 39.5 | 98.6 | 17.8 | 97.7 | 18.6 | 96.4 | 104.5 | 98.6 |
| 120 | 34.1 | 97.2 | 18 | 98.2 | 18.7 | 96.9 | N/A | N/A |
| 240 | N/A | N/A | 18.3 | 98.5 | 18.9 | 97.6 | N/A | N/A |
| 360 | N/A | N/A | 18.8 | 98.8 | 19.4 | 97.8 | N/A | N/A |
| 480 | N/A | N/A | 19.9 | 99 | 19.9 | 98.3 | N/A | N/A |
| 600 | N/A | N/A | 21.6 | 99.1 | 22.7 | 98.3 | N/A | N/A |

Based on the capacity test described in Table 6, the working time (indicated by sharp dP increase) of ACCB filter configuration was between 30 and 60 seconds, which was much lower than that of AFCCB and AFCEB. The steep reduction of dP in ACCB configuration from second 60^{th} to second 120^{th} of the test can be due to suffusion or disintegration of the filtration element (the combination of layers).

For the AFCCB and AFCEB configurations the working time was between 360 and 480 seconds (when the pressure drop gradient rapidly increases) under the same working conditions as for ACCB, which indicates that the capacity of AFCCB and of AFCEB configurations is at least 6 times higher than of ACCB configuration.

Interestingly, the capacity of a commercial N95 respirator was between 30 and 60 seconds, under the same test conditions, i.e., much lower than that of the present disclosure.

The improved capacity of AFCCB and AFCEB is explained by the presence of at least one hydrophilic layer within the layers' arrangement.

1. A filtration element comprising a proximal filtration layer, a distal filtration layer and at least one filtration layer placed between the proximal filtration layer and the distal filtration layer, each filtration layer comprising a non-woven (NW) fabric having a filtration degree;
wherein the proximal filtration layer and the distal filtration layer have, independently, a filtration degree that is lower than the filtration degree of the at least one filtration layer placed between the proximal filtration layer and the distal filtration layer.

2. The filtration element of claim 1, comprising at least one layer that comprises a hydrophilic NW fabric.

3. The filtration element of claim 2, wherein the hydrophilic NW fabric forms part of the proximal filtration layer.

4. The filtration element of claim 2, wherein the hydrophilic NW fabric forms part of the distal filtration layer.

5. The filtration element of claim 1, comprising a single filtration layer placed between the proximal filtration layer and the distal filtration layer.

6. The filtration element of claim 1, comprising two or more filtration layers placed between the proximal filtration layer and the distal filtration layer, each having a same or different filtration degree.

7. The filtration element of claim 6, wherein at least one of the two or more filtration layers placed between the proximal filtration layer and the distal filtration layer comprises a hydrophilic NW fabric.

8. The filtration element of claim 1, comprising at least two hydrophilic NW fabrics, wherein at least one hydrophilic NW fabric forms or constitutes part of the proximal filtration layer and at least one other hydrophilic NW fabric forms or constitutes part of the filtration layer placed between the proximal filtration layer and the distal filtration layer.

9. The filtration element of claim 1, wherein the proximal filtration layer, the distal filtration layer and a filtration layer placed between the proximal filtration layer and the distal filtration layer are superimposed on each other.

10. The filtration element of claim 1, wherein the proximal filtration layer, the distal filtration layer and a filtration layer placed between the proximal filtration layer and the distal filtration layer are fixedly attached one to another.

11. The filtration element of claim 10, wherein the proximal filtration layer, the distal filtration layer and the filtration layer placed between the proximal filtration layer and the distal filtration layer are fixedly attached one to another by heat welding and/or sewing.

12. The filtration element of claim 11, wherein the heat welding and/or sewing is at periphery sections of the layers.

13. The filtration element of claim 1, in a form of face mask.

14. The filtration element of claim 1, wherein the proximal filtration layer is configured for being in contact with a subject's skin, when worn by the subject.

15. A personal protective equipment comprising the filtration element, comprising:
a proximal filtration layer,
a distal filtration layer and
at least one filtration layer placed between the proximal filtration layer and the distal filtration layer, each filtration layer comprising a non-woven (NW) fabric having a filtration degree; and
wherein the proximal filtration layer and the distal filtration layer have, independently, a filtration degree that is lower than the filtration degree of the at least one filtration layer placed between the proximal filtration layer and the distal filtration layer.

16. The personal protective equipment of claim 15, being in a form of a respirator configured to be worn on a subject's face.

17. The personal protective equipment of claim 15, being in a form of an outfit configured to be worn on a subject's body.

18. A method for protecting a subject body, the method comprising applying onto the subject's body or part thereof a filtration element comprising a proximal filtration layer, a distal filtration layer and at least one filtration layer placed between the proximal filtration layer and the distal filtration layer, each filtration layer comprising a non-woven (NW) fabric having a filtration degree;
wherein the proximal filtration layer and the distal filtration layer have, independently, a filtration degree that is lower than the filtration degree of the at least one filtration layer placed between the proximal filtration layer and the distal filtration layer.

19. The method of claim 18, comprising securing the filtration element to the subject's body.

20. A method of producing a personal protective equipment, the method comprises superimposing a proximal filtration layer, a distal filtration layer and at least one additional filtration layer, placed between the proximal filtration layer and the distal filtration layer, each filtration layer comprising a non-woven (NW) fabric having a filtration degree;
wherein the proximal filtration layer and the distal filtration layer have, independently, a filtration degree that is lower than the filtration degree of the at least one filtration layer placed therebetween.
